(19) United States
(12) Patent Application Publication
(10) Pub. No.: US 2012/0268698 A1
(43) Pub. Date: Oct. 25, 2012

(54) COLOR FILTER SUBSTRATE AND DISPLAY DEVICE

(75) Inventors: Yi-Ching Wang, Hsinchu (TW); Shen-Chi Tsan, Hsinchu (TW)

(73) Assignee: E Ink Holdings Inc., Hsinchu City (TW)

(21) Appl. No.: 13/091,413

(22) Filed: Apr. 21, 2011

(51) Int. Cl. G02F 1/1335

(52) U.S. Cl. 349/106; 359/885

(57) ABSTRACT

A color filter substrate includes a transparent substrate, a number of color photoresists disposed on the transparent substrate and a high-reflecting region disposed on the transparent substrate. The high-reflecting region at least includes a first region for separating the color photoresists. The high-reflecting region either is filled with a reflecting material or is empty. A display device is also provided. The display device includes a lower substrate, a driving circuit layer disposed on the lower substrate, a display layer disposed on the driving circuit layer and the above-mentioned color filter substrate disposed on the display layer. The color filter substrate can be assembled to the display device to increase the total light intensity of light reflection, thereby improving the display quality of the display device.

### BACKGROUND

1. Technical Field

The present invention relates to a display device, more particularly to a color filter substrate and a display device applied such color filter substrate.

2. Description of the Related Art

Traditional electrophoretic display devices are black and white display devices. In order to make the electrophoretic display devices stand more competitive power, the color filter substrates are generally used to achieve a colorful effect of the traditional electrophoretic display devices. Thus, the electrophoretic display devices can satisfy the colorful trend of the current display devices.

FIG. 1 is a schematic, cross-sectional view of a traditional color filter substrate. Referring to FIG. 1, a traditional color filter substrate 300 includes a number of red photoresists 311, a number of green photoresists 312 and a number of blue photoresists 313 disposed on a transparent substrate 310. The red photoresists 311, the green photoresists 312 and the blue photoresists 313 are separated by a black matrix (BM) 314. The red photoresists 311, the green photoresists 312 and the blue photoresists 313 are used for filtering the white light into the red light, the green light and the blue light so that a display device having the traditional color filter substrate 300 is capable of displaying a color image.

The black matrix 314 of the traditional color filter substrate 300 is capable of shielding light and reducing light leakage. However, when the traditional color filter substrate 300 with the black matrix 314 is applied in a reflective display device, more light wastage will be generated. Furthermore, during transmission of the light, because the light must be absorbed twice by the red photoresists 311, the green photoresists 312 and the blue photoresists 313 of the traditional color filter substrate 300, the total light intensity of the light reflected from the display device is decreased. The display brightness is accordingly influenced by the decrease of the total light intensity of the light, thereby affecting the display quality of the display device.

### BRIEF SUMMARY

The present invention is to provide a color filter substrate, which has a high light reflectivity, and facilitates increasing the reflecting brightness of the display device, thereby improving the display quality of the display device.

The present invention is to also provide a display device, which has a high reflecting brightness and is benefit for improving the display quality of the display device.

To achieve the above-mentioned advantages, the present invention provides a color filter substrate. The color filter substrate includes a transparent substrate, a number of color photoresists disposed on the transparent substrate and a high-reflecting region disposed on the transparent substrate. The high-reflecting region at least includes a first region for separating the color photoresists. The high-reflecting region either is filled with a reflecting material or is empty.

In an embodiment of the present invention, the reflecting material is a white photoresist. In an embodiment of the present invention, the reflecting material is a translucent white photoresist. In an embodiment of the present invention, the color filter photoresists are either composed of a number of red photoresists, a number of green photoresists and a number of blue photoresists, or composed of a number of cyan photoresists, a number of carmine photoresists, and a number of yellow photoresists.

To achieve the above-mentioned advantages, the present invention also provides a display device. The display device includes a lower substrate, a driving circuit layer disposed on the lower substrate, a display layer disposed on the driving circuit layer and a color filter substrate disposed on the display layer. The color filter substrate includes an upper substrate, a number of color photoresists disposed between the upper substrate and the display layer, and a high-reflecting region disposed between the upper substrate and the display layer. The high-reflecting region at least includes a first region for separating the color photoresists. The high-reflecting region is filled with a reflecting material.

In an embodiment of the present invention, the reflecting material is a white photoresist. In an embodiment of the present invention, the driving circuit layer includes a number of thin film transistors. The high-reflecting region further includes a number of second regions, and the second regions are disposed over the thin film transistors respectively for reflecting the light. In an embodiment of the present invention, the reflecting material is a translucent white photoresist. In an embodiment of the present invention, the color filter photoresists are either composed of a number of red photoresists, a number of green photoresists and a number of blue photoresists, or composed of a number of cyan photoresists, a number of carmine photoresists, and a number of yellow photoresists.

In an embodiment of the present invention, the display layer is an electrophoretic layer. In an embodiment of the present invention, the electrophoretic layer is selected from a group consisting of a microcapsule electrophoretic display layer, a microcup electrophoretic display layer and a groove type electrophoretic display layer. In an embodiment of the present invention, the driving circuit layer is either an active matrix driving circuit layer or a passive matrix driving circuit layer. In an embodiment of the present invention, the display layer is a liquid crystal display layer.

In an embodiment of present invention, the high-reflecting region further includes a number of third regions, and the third regions are disposed on a number of sub-pixel electrodes of the driving circuit layer respectively.

To achieve the above-mentioned advantages, the present invention further provides a display device. The display device includes a lower substrate, a driving circuit layer disposed on the lower substrate, a display layer disposed on the driving circuit layer and a color filter substrate disposed on the display layer. The color filter substrate includes an upper substrate, and a number of color photoresists disposed between the upper substrate and the display layer. The color photoresists are separated by a high-reflecting region, the high-reflecting region is empty, and at least includes a first region.

In the present invention, the color filter substrate includes the high-reflecting region, and the high-reflecting region at least includes the first region for separating the color photoresists. Therefore, when the high-reflecting region is filled with the reflecting material, the light can not pass through the color filter substrate but is directly reflected by the reflecting material, thereby increasing the total light reflectivity of a display panel of the display device, and further increasing the total light intensity of the light reflected by the display panel. When the high-reflecting region is empty, the light can not be absorbed by the color filter substrate for many times but is directly illuminated on the display panel, thereby increasing the total light intensity of the light reflected by the display panel, and further increasing the total light reflectivity. Thus, the color filter substrate is benefit for increasing the display brightness of the display device, and further improving display quality of the display device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, cross-sectional view of a traditional color filter substrate.

FIG. 2 is a schematic, top view of a color filter substrate according to a first embodiment of the present invention.

FIG. 3 is a schematic, top view of a color filter substrate according to a second embodiment of the present invention.

FIG. 4 is a schematic, cross-sectional view of a display device according to an embodiment of the present invention.

FIG. 5 is a schematic, top view of a color filter substrate according to a third embodiment of the present invention.

FIG. 6 is a schematic, top view of a color filter substrate according to a fourth embodiment of the present invention.

FIG. 7 is a schematic, top view of a color filter substrate according to a fifth embodiment of the present invention.

FIG. 8 is a schematic, top view of a color filter substrate according to a sixth embodiment of the present invention.

FIG. 9 is a schematic, top view of a color filter substrate according to a seventh embodiment of the present invention.

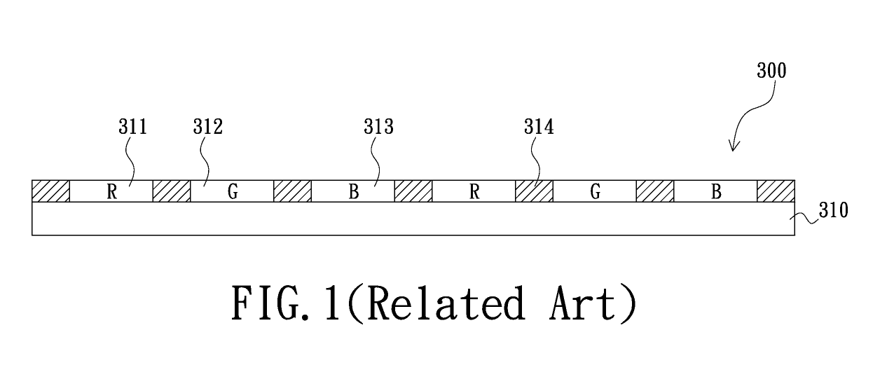

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

A color filter substrate includes a plurality of pixels. Because the pixels have similar structures, in the following drawings, the color filter substrate is represented by one of the pixels of the color filter substrate.

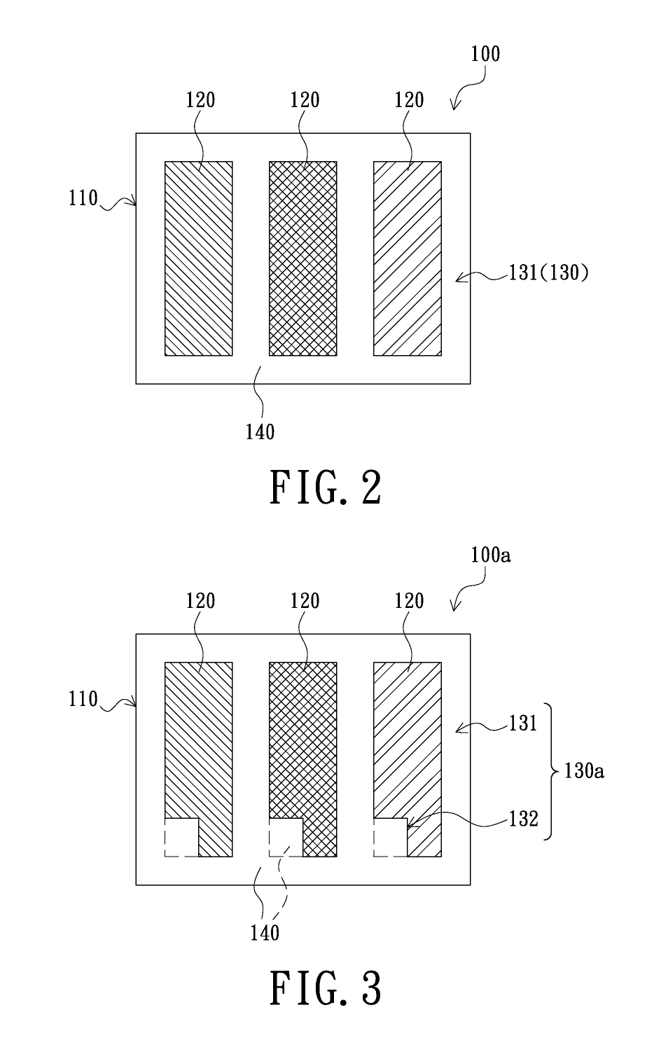

FIG. 2 is a schematic, top view of a color filter substrate according to a first embodiment of the present invention. Referring to FIG. 2, a color filter substrate 100 includes a transparent substrate 110, a number of color photoresists 120 disposed on the transparent substrate 110 and a high-reflecting region 130 disposed on the transparent substrate 110. It should be noted that, only one of the pixels including either a red photoresist, a green photoresist and a blue photoresist, or a cyan photoresist, a carmine photoresist, and a yellow photoresist, is shown in FIG. 2, and only a part of the high-reflecting region 130 corresponding to one of the pixels is shown in FIG. 2. In the present embodiment, each of the pixels includes three sub-pixels. The sub-pixels are arranged, but not limited to, from left to right. The red photoresist, the green photoresist and the blue photoresist each corresponds to a sub-pixel. Or the cyan photoresist, the carmine photoresist, and the yellow photoresist each corresponds to a sub-pixel.

The high-reflecting region 130 includes a first region 131 for separating the color photoresists 120, i.e., the red photoresist, the green photoresist and the blue photoresist, or the cyan photoresist, the carmine photoresist, and the yellow photoresist. In the present embodiment, the first region 131 is grid-shaped and configured for separating the color photoresists 120 of the pixels. In the present embodiment, the high-reflecting region 131 is filled with a reflecting material 140. The reflecting material 140 is, for example, a white photoresist with high reflectivity. When the first region 131 is filled with the reflecting material 140, a part of the incidence light to the color filter substrate 100 can not pass through the color filter substrate 100 but is directly reflected by the reflecting material 140. Therefore, when the color filter substrate 100 is applied to a display device, the total reflectivity of the display panel of the display device is increased, and the total light intensity of light reflected by the display panel of the display device is further increased, thereby improving the display quality of the display device.

FIG. 3 is a schematic, top view of a color filter substrate according to a second embodiment of the present invention. Referring to FIG. 3, a color filter substrate 100a of the second embodiment is substantially similar to the color filter substrate 100 of the first embodiment except that a high-reflecting region 130a further includes a number of second regions 132. The second regions 132 are disposed in the color photoresists 120 respectively. The second regions 132 are disposed over the thin film transistors of the display device respectively for reflecting the light. The second regions 132 are also capable of shielding the light to prevent the light from arriving at the thin film transistors and further to prevent the thin film transistors from generating a leakage current. The color filter substrate 100a is generally disposed on a display layer of the display device so that the display device is capable of displaying a color image. For the convenience of description, the display device is illustrated as an example for description of the second regions 132 of the high-reflecting region 130a of the color filter substrate 100a.

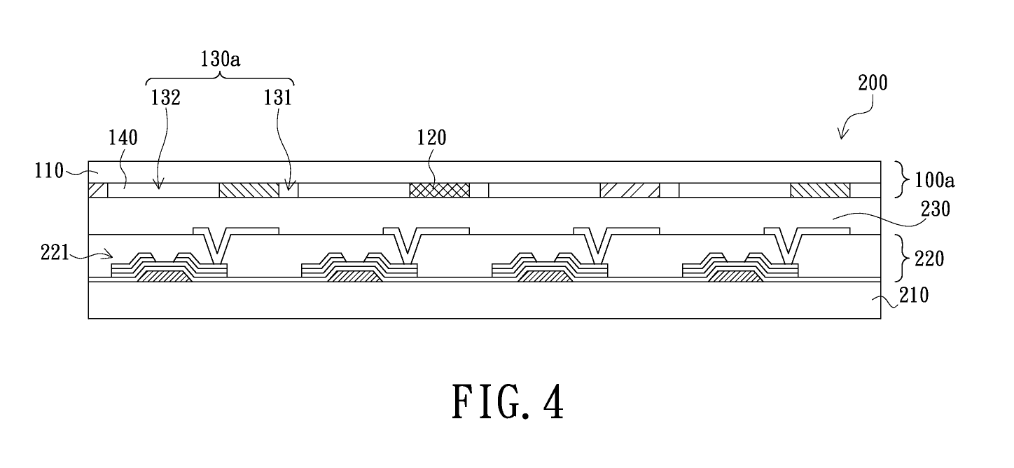

FIG. 4 is a schematic, cross sectional view of the display device according to an embodiment of the present invention. Referring to FIGS. 3 and 4, a display device 200 includes a lower substrate 210, a driving circuit layer 220, a display layer 230 and the above-mentioned color filter substrate 100a. The driving circuit layer 220 is disposed on the lower substrate 210. The driving circuit layer 220 includes a number of thin film transistors 221. The display layer 230 is disposed on the driving circuit layer 220. The color filter substrate 100a is disposed on the display layer 230. As mentioned above, the color filter substrate 100a includes the transparent substrate 110 (also named upper substrate), the color photoresists 120 disposed between the transparent substrate 110 and the display layer 230, and the high-reflecting region 130a disposed between the transparent substrate 110 and the display layer 230.

When the color filter substrate 100a is disposed on the display layer 230, the second regions 132 of the high-reflecting region 130a are disposed over the thin film transistors 221 respectively. One of the high-reflecting region 130a corresponds to one of the thin film transistors 221. In the present embodiment, the second regions 132 are, but not limited to, rectangular. The second regions 132 can also be other shape which is capable of preventing the light from arriving at the thin film transistors 221. The second regions 132 are filled with the reflecting material 140 such as the white photoresist with high reflectivity. When the second regions 132 are filled with the reflecting material 140, the light is directly reflected by the reflecting material 140 and can not arrive at the thin film transistors 221. Thus, the reflecting material 140 of the second regions 132 is capable of shielding the light and further effectively preventing the light from arriving at the thin film transistors 221, thereby preventing the thin film transistors 221 from generating a leakage current. Meanwhile, the reflecting material 140 of the second regions 132 directly reflects the light, which can also increase the total light intensity of the display device 200.

In the present embodiment, according to the type of the display device 200, the display layer 230 can be an electrophoretic display layer such as a microcapsule electrophoretic display layer, a microcup electrophoretic display layer, or a groove type electrophoretic display layer. The display layer 230 also can be a liquid crystal display layer. According to the driving manner, the driving circuit layer 220 can be either an active matrix driving circuit layer or a passive matrix driving circuit layer.

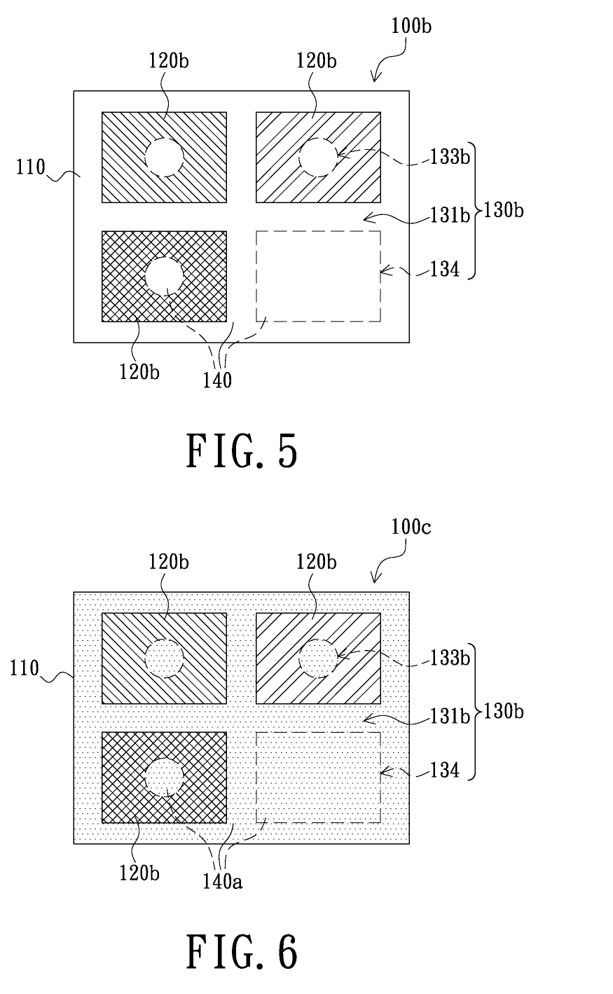

FIG. 5 is a schematic, top view of a color filter substrate according to a third embodiment of the present invention. Referring to FIG. 5, similar to the first embodiment, a color filter substrate 100b in the present embodiment includes the transparent substrate 110, a number of color photoresists 120b disposed on the transparent substrate 110 and a high-reflecting region 130b disposed on the transparent substrate 110. It should be noted that, only one of the pixels including either a red photoresist, a green photoresist and a blue photoresist, or a cyan photoresist, a carmine photoresist and a yellow photoresist, is shown in FIG. 5, and only a part of the high-reflecting region 130b corresponding to one of the pixels is shown in FIG. 5. In the present embodiment, each of the pixels includes four sub-pixels and the sub-pixels are arranged, but not limited to, in a 2-2 array (i.e., arrangement including 2 rows and 2 columns, each row has two of the four sub-pixels, and each column has two of the four sub-pixels). The red photoresist, the green photoresist and the blue photoresist each corresponds to a sub-pixel. Or, the cyan photoresist, the carmine photoresist, and the yellow photoresist each corresponds to a sub-pixel.

The high-reflecting region 130b includes a first region 131b for separating the color photoresists 120b, i.e., the red photoresist, the green photoresist and the blue photoresist, or the cyan photoresist, the carmine photoresist and the yellow photoresist. In the present embodiment, the first region 131b is grid-shaped and is configured for separating the color photoresists 120b of the pixels. In the present embodiment, the first regions 131b are filled with the reflecting material 140 such as a white photoresist with high reflectivity. Furthermore, the high-reflecting region 130b further includes a number of third regions 133b. The third regions 133b are disposed in the color photoresists 120b respectively. The third regions 133b are disposed over the sub-pixel electrodes respectively. In the present embodiment, the third regions 133b is, but not limited to, circular. Moreover, the high-reflecting region 130b further includes a fourth region 134. When the color filter substrate 100b is disposed on the display layer 230, for one of the pixels, the fourth region 134 of the high-reflecting region 130b is disposed in the sub-pixel region without the color photoresist 120, and furthermore is disposed over the corresponding sub-pixel electrode entirely. In other embodiments, it is not necessary to dispose the driving elements such as the sub-pixel electrode and the thin film transistor below the fourth region 134, but is not limited.

The third regions 133b and the fourth region 134 are filled with the reflecting material 140 such as a white photoresist with high reflectivity. When the third regions 133b and the fourth region 134 are filled with the reflecting material 140, the light is directly reflected by the reflecting material 140 and can not arrive at the sub-pixel electrodes. Therefore, the light can not affect the sub-pixel electrodes and the display quality of the display device is further improved. Meanwhile, the reflecting material 140 of third regions 133b and the fourth region 134 directly reflect the light, which can also increase the total light intensity of the light reflected by the display device 200.

FIG. 6 is a schematic, top view of a color filter substrate according to a fourth embodiment of the present invention. Referring to FIG. 6, a color filter substrate 100c of the fourth embodiment is substantially similar to the color filter substrate 100b of the third embodiment except that the reflecting material 140a filled in the high-reflecting region 130b is, for example, a translucent white photoresist. When the high-reflecting region 130b is filled with the reflecting material 140a, a part of the light passes through the reflecting material 140a, and the other part the light is reflected by the reflecting material 140a. Therefore, the total reflectivity of the display device is still increased, and the total light intensity of the light reflected by the display panel of the display device is further increased.

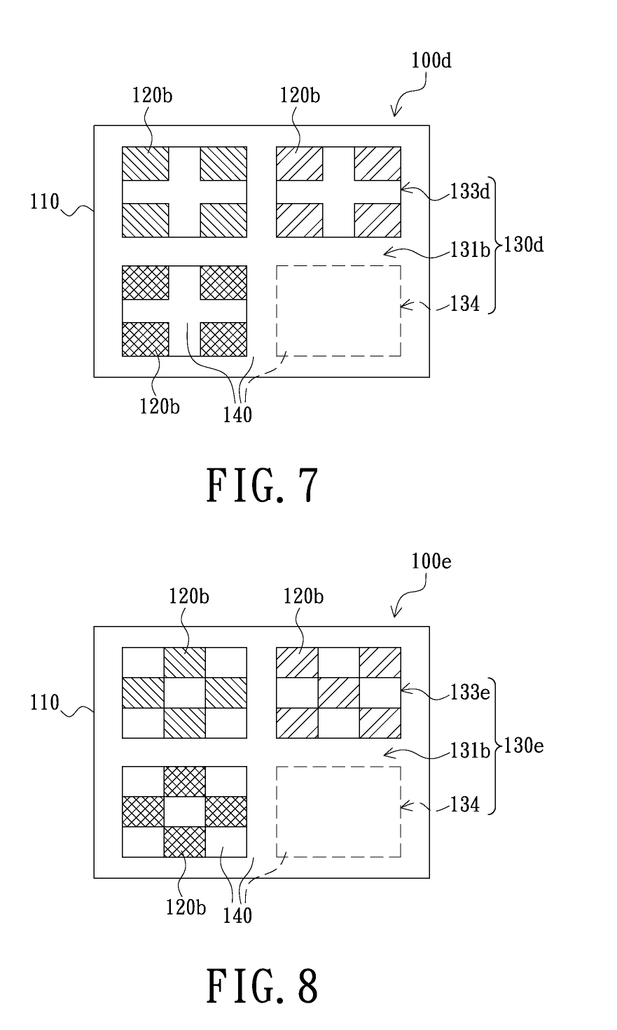

Furthermore, the configuration of the second region is not limited, the fifth and the sixth embodiments of the present invention illustrate the other two possible configurations of the second region respectively. FIG. 7 is a schematic, top view of a color filter substrate according to a fifth embodiment of the present invention. Referring to FIG. 7, a color filter substrate 100d of the fifth embodiment is substantially similar to the color filter substrate 100b of the third embodiment except that a third region 133d of the high-reflecting region 130d is in a cross-shaped configuration. FIG. 8 is a schematic, top view of a color filter substrate according to a sixth embodiment of the present invention. Referring to FIG. 8, a color filter substrate 100e of the sixth embodiment is substantially similar to the color filter substrate 100b of the third embodiment except that a third region 133e of the high-reflecting region 130e is a region assembled by a number of rectangular regions.

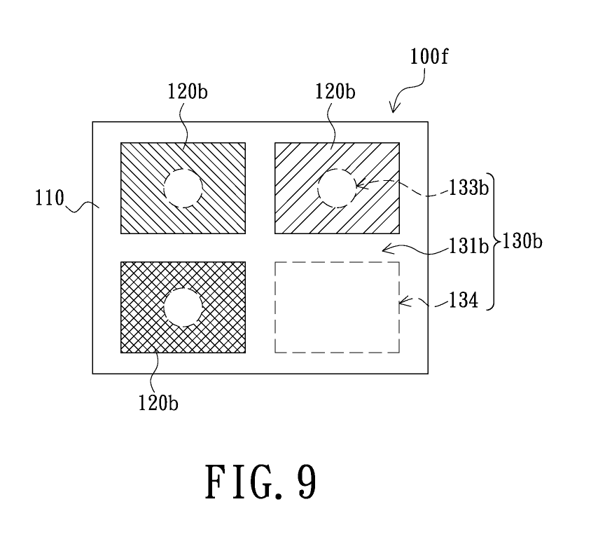

FIG. 9 is a schematic, top view of a color filter substrate according to a seventh embodiment of the present invention. Referring to FIG. 9, a color filter substrate 100f of the sixth embodiment is substantially similar to the color filter substrate 100b of the third embodiment except that the high-reflecting region 130b is empty. In detail, the high-reflecting region 130b is not filled with any material. A part of the incidence light arriving at the color filter substrate 100f directly passes through the high-reflecting region 130b, and further passes through the transparent substrate 110, and is reflected by the display panel of the display device. Thus, the total light intensity of the light reflected by the display panel of the display device can be increased, thereby increasing the total reflectivity of the display device.

Also referring to FIG. 3, the color filter substrate 100a, 100b, 100c, 100d, 100e, 100f of the abovementioned embodiments can substitute the color filter substrate 100 to be applied to the display device 200 and to be disclosed on the display layer 230. The detailed structure of the color filter substrate is not redundantly described herein. It should be noted that the abovementioned embodiments are not for limitation that the first region, the second region, the third region and the fourth region either are filled with reflecting material or empty. In other embodiments, the first region, the second region, the third region and the fourth region of the light-reflecting region can be filled with the same reflecting material, be filled with the different reflecting material or be empty.

As mentioned above, the color filter substrate of the present invention includes the high-reflecting region. Therefore, when the high-reflecting region is filled with the reflecting material, the light can not pass through the color filter substrate but is directly reflected by the reflecting material, thereby increasing the total reflectivity of the display device, and further increasing the total light intensity of light reflected by the display panel of the display device. When the high-reflecting region is empty, the light can not be absorbed by the color filter substrate for many times but is directly illuminated on the display device, thereby increasing the total intensity of the light reflected by the display panel of the display device, and further increasing the total reflectivity. Thus, the color filter substrate is benefit for increasing the display brightness of the display device, and further improving the display quality of the display device.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A color filter substrate, comprising:
a transparent substrate;
a plurality of color photoresists disposed on the transparent substrate; and
a high-reflecting region disposed on the transparent substrate, the high-reflecting region at least comprising a first region for separating the color photoresists, the high-reflecting region either being filled with a reflecting material or being empty.

2. The color filter substrate as claimed in claim 1, wherein the reflecting material is a white photoresist.

3. The color filter substrate as claim in claim 1, wherein the reflecting material is a translucent white photoresist.

4. The color filter substrate as claim in claim 1, wherein the color filter photoresists are either composed of a plurality of red photoresists, a plurality of green photoresists and a plurality of blue photoresists, or composed of a plurality of cyan photoresists, a plurality of carmine photoresists and a plurality of yellow photoresists.

5. A display device, comprising:
a lower substrate;
a driving circuit layer disposed on the lower substrate;
a display layer disposed on the driving circuit layer; and
a color filter substrate disposed on the display layer, the color filter substrate comprising:
an upper substrate;
a plurality of color photoresists disposed between the upper substrate and the display layer; and
a high-reflecting region disposed between the upper substrate and the display layer, the high-reflecting region at least comprising a first region for separating the color photoresists, and the high-reflecting region being filled with a reflecting material.

6. The display device as claim in claim 5, wherein the reflecting material is a white photoresist.

7. The display device as claim in claim 6, wherein the driving circuit layer comprises a plurality of thin film transistors, the high-reflecting region further comprises a plurality of second regions, and the second regions are disposed over the thin film transistors respectively for reflecting the light.

8. The display device as claim in claim 5, wherein the reflecting material is a translucent white photoresist.

9. The display device as claim in claim 5, wherein the color filter photoresists are either composed of a plurality of red photoresists, a plurality of green photoresists and a plurality of blue photoresists, or composed of a plurality of cyan photoresists, a plurality of carmine photoresists and a plurality of yellow photoresists.

10. The display device as claim in claim 5, wherein the display layer is an electrophoretic display layer.

11. The display device as claim in claim 10, wherein the electrophoretic display layer is selected from a group consisting of a microcapsule electrophoretic display layer, a microcup electrophoretic layer and a groove type electrophoretic display layer.

12. The display device as claim in claim 5, wherein the driving circuit layer is either an active matrix driving circuit layer or a passive matrix driving circuit layer.

13. The display device as claim in claim 5, wherein the display layer is a liquid crystal display layer.

14. The display device as claim in claim 5, wherein the high-reflecting region further comprises a plurality of third regions, and the third regions are disposed on a plurality of sub-pixel electrodes of the driving circuit layer respectively.

15. A display device, comprising:
a lower substrate;
a driving circuit layer disposed on the lower substrate;
a display layer disposed on the driving circuit layer; and
a color filter substrate disposed on the display layer, the color filter substrate comprising:
an upper substrate; and
a plurality of color photoresists disposed between the upper substrate and the display layer, wherein the color photoresists are separated by a high-reflecting region, the high-reflecting region is empty, and at least comprises a first region.

16. The display device as claim in claim 15, wherein the high-reflecting region further comprises a plurality of third regions, and the third regions are disposed over a plurality of sub-pixel electrodes of the driving circuit layer respectively.
